(19) United States
(12) Patent Application Publication
(10) Pub. No.: US 2021/0024050 A1
(43) Pub. Date: Jan. 28, 2021

(54) VEHICLE BRAKING DEVICE

(71) Applicant: ADVICS CO., LTD., Kariya-shi, Aichi-ken (JP)

(72) Inventor: Yoshimitsu OZEKI, Nagoya-shi, Aichi-ken, (JP)

(73) Assignee: ADVICS CO., LTD., Kariya-shi, Aichi-ken (JP)

(21) Appl. No.: 16/980,092

(22) PCT Filed: Mar. 28, 2019
(86) PCT No.: PCT/JP2019/013784

§ 371 Date: Sep. 11, 2020

(30) Foreign Application Priority Data
Mar. 30, 2018 (JP) 2018-069130

(51) Int. Cl. B60T 17/22; B60T 11/16; B60T 13/58; B60T 15/02; B60Q 9/00

(52) U.S. Cl. CPC B60T 17/221; B60T 11/165; B60Q 9/00; B60T 15/028; B60T 13/58

(57) ABSTRACT

A brake ECU automatically pressurizes a servo chamber of a master cylinder, and then determines whether a single system failure has occurred in the master system. When the single system failure is detected, a refresh drive is executed so that a fluid pressure chamber provided to the master cylinder is subjected to a negative pressure to cause a brake fluid to forcibly flow from a reservoir into the fluid pressure chamber via a seal member provided inside of the master cylinder and foreign matters caught by the seal member are thus washed out. The brake ECU again automatically pressurizes the servo chamber, determines whether the single system failure has been resolved, and notifies the occurrence of the single system failure when the single system failure has not been resolved.

### TECHNICAL FIELD

The present disclosure relates to a vehicle braking device configured to control a braking force that is applied to a vehicle in response to a driver's brake operation amount.

### BACKGROUND ART

In the related art, a vehicle braking device disclosed in PTL 1, for example, is known. The vehicle braking device of the related art moves a master piston only with a servo pressure by a servo pressure generator in a state where a brake operation member is not operated, and detects a master system failure, based on an amount of consumption of a brake fluid at that time.

### CITATION LIST

### Patent Literature

PTL 1: Japanese Unexamined Patent Application Publication No. 2013-107560

### SUMMARY OF INVENTION

### Technical Problem

The master system failure is highly likely to occur as foreign matters existing around a seal member disposed between an outer peripheral surface of the master piston and an inner peripheral surface of a main cylinder configured to slidably accommodate the master piston are caught by the seal member. In this case, when the foreign matters caught by the seal member are removed, the master system failure is resolved. Therefore, it is needed to easily remove the foreign matters caught by the seal member.

The present disclosure has been made in view of the above situation. That is, an object of the present disclosure is to provide a vehicle braking device capable of easily removing foreign matters caught by a seal member when a master system failure is detected.

### Solution to Problem

In order to achieve the above object, a vehicle braking device of Claim 1 includes a master cylinder including a main cylinder, a master piston drivably housed in the main cylinder, a fluid pressure chamber whose volume changes in response to movement of the master piston, a communication hole formed in the main cylinder so that a reservoir for reserving a brake fluid communicates with an inside of the main cylinder, and a seal member made of an elastic material provided between an inner peripheral surface of the main cylinder and an outer peripheral surface of the master piston and between the communication hole and the fluid pressure chamber; a failure detector configured to detect a failure of a master system including the master cylinder; and a negative pressure generation controller that, when the failure is detected by the failure detector, moves the master piston to generate a negative pressure in the fluid pressure chamber.

### Advantageous Effects of Invention

According to the above configuration, when a failure having occurred in the master system is detected by the failure detector, the negative pressure generation controller moves the master piston to generate a negative pressure in the fluid pressure chamber provided to the master cylinder. In this way, the negative pressure is generated in the fluid pressure chamber, so that a pressure difference from a reservoir-side, i.e., an atmospheric pressure increases and the seal member can be partially elastically deformed in a compulsory manner by the pressure difference. Thereby, the brake fluid reserved in the reservoir can be caused to flow toward the fluid pressure chamber subjected to the negative pressure, through the seal member having caught foreign matters. Therefore, the foreign matters caught by the seal member can be easily washed out by a flow of the brake fluid, so that it is possible to increase a possibility of resolving the failure having occurred in the master system.

### BRIEF DESCRIPTION OF DRAWINGS

FIG. 1 is a partially sectional schematic view depicting a configuration of a vehicle braking device in accordance with an embodiment of the present disclosure.

FIG. 2 is a partially sectional view depicting a configuration of a regulator shown in FIG. 1.

FIG. 3 illustrates a configuration of a brake ECU shown in FIG. 1.

FIG. 4 is a flowchart depicting a refresh drive control program that is executed by the brake ECU shown in FIG. 3.

FIG. 5 illustrates a refresh drive in accordance with an embodiment.

FIG. 6 is a partially sectional schematic view depicting a configuration of a vehicle braking device in accordance with a modified embodiment of the embodiment.

FIG. 7 illustrates a refresh drive in accordance with the modified embodiment.

FIG. 8 depicts a relation between a size of foreign matters and a reactive force pressure in another modified embodiment.

### DESCRIPTION OF EMBODIMENTS

Hereinbelow, an embodiment of the present disclosure will be described with reference to the drawings. In the meantime, in the embodiment and modified embodiments to be described later, the same or equivalent parts are denoted with the same reference signs in the drawings. Also, the drawings used for descriptions are conceptual views, and shapes of respective parts may not be strictly exact.

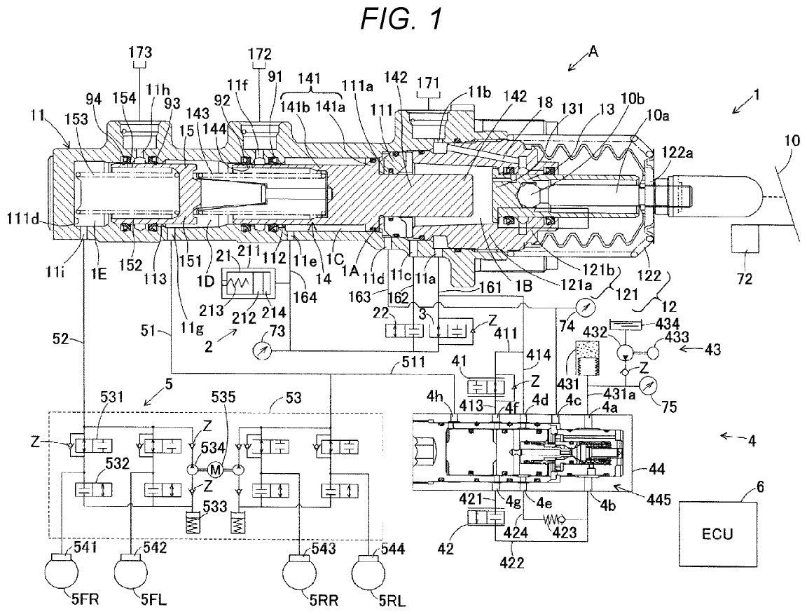

As shown in FIG. 1, a vehicle braking device A of the present embodiment includes mainly a master cylinder 1, a reactive force generation device 2, a separation lock valve 22, a reactive force valve 3, a servo pressure generation device 4 as a servo pressure generator, a brake device 5, a brake ECU 6, and a variety of sensors 72 to 75 capable of performing communication with the brake ECU 6.

The master cylinder 1 is to provide a brake fluid to the brake device 5. The master cylinder 1 includes mainly a main cylinder 11, a cover cylinder 12, an input piston 13, and a first master piston 14 and a second master piston 15 as a master piston.

The main cylinder 11 is a cylindrical (hollow) bottomed cylinder having an opening at one end and a bottom surface at the other end. In descriptions below, regarding the master cylinder 1, an opening-side of the main cylinder 11 is referred to as the rear, and a bottom surface-side of the main cylinder 11 is referred to as the front. The main cylinder 11 is provided therein with an inner wall part 111 for separating the opening-side and bottom surface-side of the main cylinder 11. A center of the inner wall part 111 is formed with a through-hole 111a penetrating in an axial direction that is a front and rear direction.

Also, in the main cylinder 11, a small-diameter part 112 and a small-diameter part 113 of which inner diameters are each smaller than parts adjacent thereto in the axial direction are provided in front of the inner wall part 111. The small-diameter part 112 is located in front of the small-diameter part 113. In other words, the small-diameter part 112 and the small-diameter part 113 protrude toward an interior direction from an entire circumference at axial parts of an inner peripheral surface of the main cylinder 11. The inner periphery direction is a direction in which an inner diameter of the main cylinder 11 decreases. The small-diameter part 112 is formed with two accommodation grooves in which a seal member 91 and a seal member 92, which will be described later, are disposed. The inside surfaces of the small-diameter part 112 and the seal members 91 and 92 are slid on the first master piston 14, which will be described later. The small-diameter part 113 is formed with two accommodation grooves in which a seal member 93 and a seal member 94, which will be described later, are disposed. The inside surfaces of the small-diameter part 113 and the seal members 93 and 94 are slid on the second master piston 15, which will be described later. Also, both the master pistons 14 and 15, which will be described later, are disposed slidably in the axial direction inside of the main cylinder 11. In the meantime, ports and the like for communicating an inside and an outside each other will be described later in detail.

The cover cylinder 12 has a cylindrical cylinder part 121, and a cup-shaped cover part 122. The cylinder part 121 is disposed at the rear of the main cylinder 11, and is coaxially fitted to the opening of the main cylinder 11. An inner diameter of a front portion 121a of the cylinder part 121 is formed larger than an inner diameter of a rear portion 121b. Also, the inner diameter of the front portion 121a is formed larger than an inner diameter of the through-hole 111a of the inner wall part 111.

The cover part 122 is attached to a rear end portion of the main cylinder 11 and an outer peripheral surface of the cylinder part 121 so as to close the opening of the main cylinder 11 and a rear end-side opening of the cylinder part 121. A bottom wall of the cover part 122 is formed with a through-hole 122a. The cover part 122 is configured by an elastic member that can be expanded and contracted in the axial direction, and the bottom wall is urged rearward.

The input piston 13 is a piston configured to slide inside of the cover cylinder 12, in accordance with an operation of the brake pedal 10 as a brake operation member. The input piston 13 is a cylindrical bottomed piston having a bottom surface at the front and an opening at the rear. A bottom wall 131 configuring the bottom surface of the input piston 13 has a diameter larger than other parts of the input piston 13. The input piston 13 is disposed so that the bottom wall 131 is located at a rear end of the front portion of the cylinder part 121. The input piston 13 is disposed liquid-tightly and slidably in the axial direction in the rear portion 121b of the cylinder part 121.

In the input piston 13, an operation rod 10a and a pivot 10b of the brake pedal 10 are installed. The operation rod 10a protrudes outwardly through an opening of the input piston 13 and the through-hole 122a of the cover part 122, and is connected to the brake pedal 10. The operation rod 10a is configured to move in conjunction with an operation of the brake pedal 10, and moves forward while crushing the cover part 122 in the axial direction when the brake pedal 10 is depressed. The input piston 13 is configured to move forward in conjunction with the forward movement of the operation rod 10a.

The first master piston 14 as a master piston is disposed drivably in the axial direction, inside of the main cylinder 11. Specifically, the first master piston 14 has a first main body part 141 and a protrusion 142. The first main body part 141 is coaxially disposed ahead of the inner wall part 111, inside of the main cylinder 11. The first main body part 141 has a cylindrical (hollow) bottomed shape having an opening at the front, a bottom wall 141a at the rear and a circumferential wall portion 141b connected to the bottom wall 141a.

The bottom wall 141a is disposed liquid-tightly and slidably in the axial direction with respect to the main cylinder 11, ahead of the inner wall part 111. The circumferential wall portion 141b has a cylindrical shape having a diameter smaller than the bottom wall 141a, and coaxially extends forward from a center of a front end face of the bottom wall 141a. A front portion of the circumferential wall portion 141b is disposed liquid-tightly and slidably in the axial direction with respect to the small-diameter part 112. In the meantime, a rear portion of the circumferential wall portion 141b is spaced from the inner peripheral surface of the main cylinder 11.

The protrusion 142 is a circular cylinder-shaped part protruding rearward from a center of an end face of the bottom wall 141a of the first main body part 141. The protrusion 142 is disposed liquid-tightly and slidably in the axial direction with respect to the through-hole 111a of the inner wall part 111. A rear portion of the protrusion 142 is located inside of the cylinder part 121 via the through-hole 111a. The rear portion of the protrusion 142 is spaced from an inner peripheral surface of the cylinder part 121. A rear end face of the protrusion 142 is spaced from the bottom wall 131 of the input piston 13 by a predetermined distance. The first master piston 14 is urged rearward by an urging member 143 such as a spring.

Herein, a “servo chamber 1A” is defined by a rear end face of the bottom wall 141a of the first main body part 141, a front end face of the inner wall part 111, the inner peripheral surface of the main cylinder 11, and the outer peripheral surface of the protrusion 142. Also, a “first reactive force chamber 1B” is defined by a rear end face of the inner wall part 111, an outer surface of the input piston 13, an inner peripheral surface of the front portion 121a of the cylinder part 121, and an outer surface of the protrusion 142. Also, a “second reactive force chamber 1C” is defined by a rear end face of the small-diameter part 112, an outer peripheral surface of the first master piston 14 and the inner peripheral surface of the main cylinder 11.

The second master piston 15 as a master piston is disposed coaxially and drivably in front of the first master piston 14, inside of the main cylinder 11. The second master piston 15 has a cylindrical (hollow) bottomed shape having an opening at the front, a bottom wall 151 at the rear and a circumferential wall portion 152 connected to the bottom wall 151.

The bottom wall 151 is disposed between the small-diameter part 112 and the small-diameter part 113 in front of the first master piston 14. A rear portion of the second master piston 15 including the bottom wall 151 is spaced from the inner peripheral surface of the main cylinder 11. The circumferential wall portion 152 is disposed liquid-tightly and slidably in the axial direction with respect to the small-diameter part 113. The second master piston 15 is urged rearward by an urging member 153 such as a spring.

Herein, a “first fluid pressure chamber 1D” as a fluid pressure chamber is defined by an outer surface of the second master piston 15, a front end face of the first master piston 14, an inner surface of the first master piston 14, a front end face of the small-diameter part 112, a rear end face of the small-diameter part 113, and the inner peripheral surface of the main cylinder 11 between the small-diameter part 112 and the small-diameter part 113. Also, a “second fluid pressure chamber 1E” as a fluid pressure chamber is defined by an inner bottom surface 111d of the main cylinder 11, a front end face of the second master piston 15, an inner surface of the second master piston 15, a front end face of the small-diameter part 113, and the inner peripheral surface of the main cylinder 11.

The master cylinder 1 is formed with ports 11a to 11i for communicating an inside and an outside of the master cylinder each other. The port 11a is formed at the rear of the inner wall part 111 of the main cylinder 11. The port 11b is formed to face the port 11a, in an axially similar position to the port 11a. The port 11a and the port 11b communicate with each other via a space between the inner peripheral surface of the main cylinder 11 and the outer peripheral surface of the cylinder part 121. The port 11a connects to a pipe 161. The port 11b connects to the reservoir 171. Thereby, the port 11a communicates with the reservoir 171.

Also, the port 11b communicates with the first fluid pressure chamber 1B by a passage 18 formed in the cylinder part 121 and the input piston 13. The passage 18 is disconnected when the input piston 13 is moved forward. That is, when the input piston 13 is moved forward, the first reactive force chamber 1B and the reservoir 171 are disconnected from each other.

The port 11c is formed in front of the port 11a, and communicates the first fluid pressure chamber 1B and a pipe 162 each other. The port 11d is formed in front of the port 11c, and communicates the servo chamber 1A and a pipe 163 each other. The port 11e is formed in front of the port 11d, and communicates the second reactive force chamber 1C and a pipe 164 each other.

The port 11f as a communication hole is formed between the seal member 91 and the seal member 92, and communicates the reservoir 172 and the inside of the main cylinder 11 each other. The port 11f communicates with the first fluid pressure chamber 1D via a passage 144 as a communication hole formed in the first master piston 14. The passage 144 is formed in a position at the slight rear of the seal member 92 so that the port 11f, i.e., the reservoir 172 and the first fluid pressure chamber 1D are disconnected from each other when the first master piston 14 is moved forward.

The port 11g is formed in front of the port 11f, and communicates the first fluid pressure chamber 1D and a pipe 51 each other. The port 11h as a communication hole is formed between the seal member 93 and the seal member 94, and communicates a reservoir 173 and the inside of the main cylinder 11 each other. The port 11h communicates with the second fluid pressure chamber 1E via a passage 154 as a communication hole formed in the second master piston 15. The passage 154 is formed in a position at the slight rear of the seal member 94 so that the port 11h, i.e., the reservoir 173 and the second fluid pressure chamber 1E are disconnected from each other when the second master piston 15 is moved forward. The port 11i is formed in front of the port 11h, and communicates the second fluid pressure chamber 1E and a pipe 52 each other.

Also, a seal member (refer to a black circle in the drawing) such as an O-ring is appropriately disposed in the master cylinder 1. The seal member 91 and the seal member 92 are cup seals. As described above, the seal member 91 and the seal member 92 are disposed at the small-diameter part 112, and are in contact with the outer peripheral surface of the first master piston 14 in a liquid-tight manner.

That is, the seal members 91 and 92 are provided between the inner peripheral surface of the main cylinder 11 and the outer peripheral surface of the first master piston 14. The seal members 91 and 92 are each an elastic body having an inside seal part, an outside seal part, and a connection part. The inside seal part is a part that is in contact with the first master piston 14. The outside seal part is a part that is in contact with the inner peripheral surface of the main cylinder 11. A bottom surface of the accommodation groove is a portion of the inner peripheral surface of the main cylinder 11. Therefore, it can be said that the outside seal part is a part that is in contact with the bottom surface of the accommodation groove formed in the small-diameter part 112. The outside seal part extends in the axial direction, and has a rear end that is a free end, and a front end connected to the connection part. The connection part is a part for connecting a front end of the outside seal part and the inside seal part. Thereby, the outside seal part and the inside seal part are spaced apart. The seal members 91 and 92 are elastically deformed based on the front end of the outside seal part.

Similarly, the seal member 93 and the seal member 94 are cup seals. The seal member 93 and the seal member 94 are disposed at the small-diameter part 113, and are in contact with the outer peripheral surface of the second master piston 15 in a liquid-tight manner. Similarly, the seal members 93 and 94 each have an inside seal part, an outside seal part, and a connection part. In descriptions below, the outside seal part is referred to as an outer periphery-side of the seal members 91 to 94. In the meantime, a seal member is disposed between the input piston 13 and the cylinder part 121.

A stroke sensor 72 is a sensor configured to detect a stroke amount (operation amount) of the brake pedal 10. The stroke sensor 72 is configured to transmit a detected stroke amount (operation amount) to the brake ECU 6.

The reactive force generation device 2 includes a stroke simulator 21. The stroke simulator 21 is a device configured to generate a reactive force pressure in the first reactive force chamber 1B and the second reactive force chamber 1C, in accordance with an operation of the brake pedal 10. In general, the stroke simulator 21 has a configuration where a piston 212 is slidably fitted to a cylinder 211 and a pilot fluid chamber 214 is formed on a front surface-side of the piston 212 urged forward by a compression spring 213. The stroke simulator 21 is connected to the second reactive force chamber 1C via the pipe 164 and the port 11e, and is connected to the separation lock valve 22 and the reactive force valve 3 via the pipe 164.

The separation lock valve 22 is a normally closed electromagnetic valve (linear valve), and is opened and closed by the brake ECU 6. The separation lock valve 22 is connected to the pipe 164 and the pipe 162, and is configured to connect or disconnect both the pipes 162 and 164. The separation lock valve 22 is a valve for connecting or disconnecting the first reactive force chamber 1B and the second reactive force chamber 1C.

The pressure sensor 73 is a sensor configured to mainly detect a reactive force pressure, which is a pressure in the first reactive force chamber 1B and the second reactive force chamber 1C. When the separation lock valve 22 is in an open position, the pressure sensor 73 detects the reactive force pressure in the first reactive force chamber 1B and the second reactive force chamber 1C, and when the separation lock valve 22 is in a close position, the pressure sensor 73 detects the reactive force pressure in the second reactive force chamber 1C.

The reactive force valve 3 is a normally open electromagnetic valve, and is opened and closed by the brake ECU 6. The reactive force valve 3 is connected to the pipe 164 and the pipe 161, and is configured to connect or disconnect both the pipes 161 and 164. The reactive force valve 3 is a valve for connecting or disconnecting the first reactive force chamber 1B and second reactive force chamber 1C and the reservoir 171.

Herein, control on the reactive force valve 3 and the separation lock valve 22 by the brake ECU 6 upon an operation on a brake is described. When the brake pedal 10 is depressed, the input piston 13 is moved forward and the passage 18 is disconnected, so that the reservoir 171 and the first reactive force chamber 1B are cut off each other. At the same time, the reactive force valve 3 is switched from an open position to a close position, and the separation lock valve 22 is switched from a close position to an open position. The reactive force valve 3 is switched to the close position, so that the second reactive force chamber 1C disconnects from the reservoir 171. The separation lock valve 22 is switched to the open position, so that the first reactive force chamber 1B connects with the second reactive force chamber 1C. That is, the input piston 13 is moved forward and the reactive force valve 3 is switched to the close position, so that the first reactive force chamber 1B and the second reactive force chamber 1C disconnects from the reservoir 171. Then, the stroke simulator 21 generates a reactive force pressure corresponding to a stroke amount in the first reactive force chamber 1B and the second reactive force chamber 1C.

The servo pressure generation device 4 as a servo pressure generator includes mainly a pressure reducing valve 41, a pressure increasing valve 42, a pressure supply unit 43, and a regulator 44. The pressure reducing valve 41 is a normally open electromagnetic valve, and a flow rate thereof is controlled by the brake ECU 6. One side of the pressure reducing valve 41 is connected to the pipe 161 via a pipe 411, and the other side of the pressure reducing valve 41 is connected to a pipe 413. Thereby, one side of the pressure reducing valve 41 communicates with the reservoir 171 via the pipe 411, the pipe 161, the port 11a and the port 11b. The pressure increasing valve 42 is a normally closed electromagnetic valve, and a flow rate thereof is controlled by the brake ECU 6. One side of the pressure increasing valve 42 is connected to a pipe 421, and the other side of the pressure increasing valve 42 is connected to a pipe 422.

The pressure supply unit 43 is configured to provide a high-pressure brake fluid to the regulator 44, based on an instruction of the brake ECU 6. The pressure supply unit 43 includes mainly an accumulator 431, a fluid pressure pump 432, a motor 433, and a reservoir 434.

The accumulator 431 is to accumulate a fluid pressure generated by the fluid pressure pump 432. The accumulator 431 is connected to the regulator 44, the pressure sensor 75 and the fluid pressure pump 432 by a pipe 431a. The fluid pressure pump 432 is connected to the motor 433 and the reservoir 434. The fluid pressure pump 432 is configured to supply the brake fluid reserved in the reservoir 434 to the accumulator 431 as the motor 433 is driven. The pressure sensor 75 is configured to detect a pressure in the accumulator 431 (hereinbelow, referred to as “accumulator pressure”). The accumulator pressure detected by the pressure sensor 75 has correlation with an amount of consumption of the brake fluid accumulated by the accumulator 431. In addition to the accumulator pressure, a servo pressure that is increased using the brake fluid in the accumulator 431 and a reactive force pressure that is increased as the servo pressure is increased have correlation with the amount of consumption of the brake fluid.

When the pressure sensor 75 detects that the accumulator pressure is lowered to a predetermined value or smaller, the brake ECU 6 outputs a control signal to drive the motor 433. Thereby, the fluid pressure pump 432 supplies the brake fluid to the accumulator 431 to accumulate the fluid pressure in the accumulator 431.

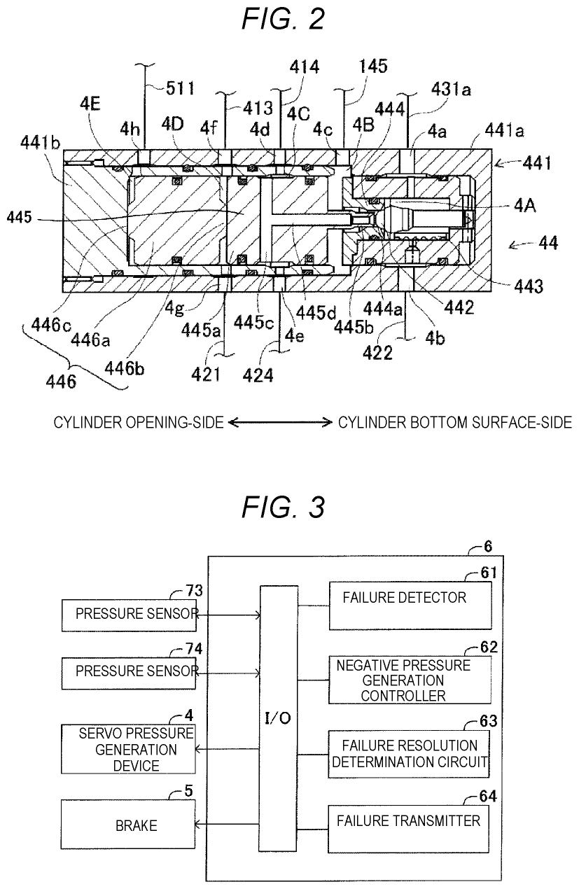

The regulator 44 has a configuration where a sub-piston 446 is mainly added to a general regulator. That is, as shown in FIG. 2, the regulator 44 of the present embodiment includes mainly a cylinder 441, a ball valve 442, an urging part 443, a valve seat part 444, a control piston 445, and a sub-piston 446.

The cylinder 441 is configured by a cylindrical bottomed cylinder case 441a having a bottom surface on one side (the right side in FIG. 2), and a cover member 441b that closes an opening (the left side in FIG. 2) of the cylinder case 441a. The cylinder case 441a is provided with a plurality of ports 4a to 4h for communicating an inside and an outside.

The port 4a connects to the pipe 431a. The port 4b connects to the pipe 422. The port 4c connects to the pipe 163. The port 4d connects to the pipe 161 via the pipe 411. The port 4e connects to a pipe 424 that communicates with the pipe 422 via a relief valve 423. The port 4f connects to the pipe 413. The port 4g connects to the pipe 421. The port 4h connects to a pipe 511 branched from the pipe 51.

The ball valve 442 is a ball type valve, and is disposed on a bottom surface-side of the cylinder case 441a (hereinbelow, referred to as “cylinder bottom surface-side”), inside of the cylinder 441. The urging part 443 is a spring member for urging the ball valve 442 toward an opening-side of the cylinder case 441a (hereinbelow, also referred to as “cylinder opening-side”), and is disposed on a bottom surface of the cylinder case 441a. The valve seat part 444 is a wall member provided on an inner peripheral surface of the cylinder case 441a, and demarcates the cylinder opening-side and the cylinder bottom surface-side each other. A center of the valve seat part 444 is formed with a passage 444a for communicating the demarcated cylinder opening-side and cylinder bottom surface-side each other. The valve seat part 444 holds the ball valve 442 from the cylinder opening-side so that the urged ball valve 442 closes the passage 444a.

A space defined by the ball valve 442, the urging part 443, the valve seat part 444, and an inner peripheral surface of the cylinder case 441a on the cylinder bottom surface-side is referred to as a first chamber 4A. The first chamber 4A is filled with the brake fluid, and is connected to the pipe 431a via the port 4a, and is connected to the pipe 422 via the port 4b.

The control piston 445 has a circular cylinder-shaped main body part 445a, and a circular cylinder-shaped protrusion 445b having a diameter smaller than the main body part 445a. The main body part 445a is disposed coaxially, liquid-tightly and slidably in the axial direction on the cylinder opening-side of the valve seat part 444, inside of the cylinder 441. The main body part 445a is urged toward the cylinder opening-side by an urging member (not shown). A central portion of the main body part 445a in the axial direction is formed with a passage 445c having both ends opened in a circumferential surface of the main body part 445a and extending in a circumferential direction (the upper and lower direction in FIG. 2). An inner peripheral surface of a part of the cylinder 441 corresponding to a position of an opening of the passage 445c is formed with the port 4d and is recessed in a concave shape to form a third chamber 4C with the main body part 445a.

The protrusion 445b protrudes from a center of an end face of the main body part 445a on the cylinder bottom surface-side toward the cylinder bottom surface-side. A diameter of the protrusion 445b is smaller than the passage 444a of the valve seat part 444. The protrusion 445b is disposed coaxially with the passage 444a. A tip end of the protrusion 445b is distant from the ball valve 442 toward the cylinder opening-side by a predetermined distance. The protrusion 445b is formed with a passage 445d extending in the axial direction and opened on a center of an end face of the protrusion 445b on the cylinder bottom surface-side. The passage 445d extends into the main body part 445a, and connects to the passage 445c.

A space defined by an end face of the main body part 445a on the cylinder bottom surface-side, an outer surface of the protrusion 445b, an inner peripheral surface of the cylinder 441, the valve seat part 444, and the ball valve 442 is referred to as “second chamber 4B”. The second chamber 4B communicates with the ports 4d and 4e via the passages 445c and 445d and the third chamber 4C.

The sub-piston 446 has a sub-main body part 446a, a first protrusion 446b, and a second protrusion 446c. The sub-main body part 446a has a circular cylinder shape. The sub-main body part 446a is disposed coaxially, liquid-tightly and slidably in the axial direction on the cylinder opening-side of the main body part 445a, inside of the cylinder 441.

The first protrusion 446b has a circular cylinder shape of which a diameter is smaller than the sub-main body part 446a, and protrudes from a center of an end face of the sub-main body part 446a on the cylinder bottom surface-side. The first protrusion 446b is in contact with an end face of the main body part 445a on the cylinder opening-side. The second protrusion 446c has the same shape as the first protrusion 446b, and protrudes from a center of an end face of the sub-main body part 446a on the cylinder opening-side. The second protrusion 446c is in contact with the cover member 441b.

A space defined by an end face of the sub-main body part 446a on the cylinder opening-side, an outer surface of the first protrusion 446b, an end face of the control piston 445 on the cylinder opening-side, and the inner peripheral surface of the cylinder 441 is referred to as a pressure control chamber 4D. The pressure control chamber 4D communicates with the pressure reducing valve 41 via the port 4f and the pipe 413, and communicates with the pressure increasing valve 42 via the port 4g and the pipe 421.

In the meantime, a space defined by the end face of the sub-main body part 446a on the cylinder opening-side, an outer surface of the second protrusion 446c, the cover member 441b, and the inner peripheral surface of the cylinder 441 is referred to as a fourth chamber 4E. The fourth chamber 4E communicates with the port 11g via the port 4h and the pipes 511 and 51. The first chamber 4A, the second chamber 4B, the third chamber 4C and the fourth chamber 4E are filled with the brake fluid. The pressure sensor 74 is a sensor configured to detect a pressure (servo pressure) in the servo chamber 1A, and is connected to the pipe 163.

The brake device 5 has a configuration where the first fluid pressure chamber 1D and the second fluid pressure chamber 1E each configured to generate a master cylinder pressure, a wheel cylinder 541, a wheel cylinder 542, a wheel cylinder 543 and a wheel cylinder 544 communicate via the pipe 51, the pipe 52 and the brake actuator 53. Specifically, the port 11g of the first fluid pressure chamber 1D and the port 11i of the second fluid pressure chamber 1E connect to a well-known brake actuator 53 via the pipe 51 and the pipe 52, respectively. The brake actuator 53 is configured to execute an antilock brake control (ABS control), a side slip prevention control (ESC) and the like, for example. The brake actuator 53 is coupled to the wheel cylinder 541 to the wheel cylinder 544 each configured to operate for braking each of a wheel 5FR, a wheel 5FL, a wheel 5RR and a wheel 5RL.

Herein, the brake actuator 53 is described with reference to a configuration of the wheel 5FR that is one of four wheels. In the meantime, the descriptions of the other wheels (the wheel 5FL, the wheel 5RR and the wheel 5RL) are omitted because the configurations thereof are similar to the wheel 5FR. The brake actuator 53 includes a holding valve 531, a pressure reducing valve 532, a reservoir 533, a pump 534, and a motor 535. The holding valve 531 is a normally open electromagnetic valve, and is opened and closed by the brake ECU 6. The holding valve 531 is disposed so that one side is connected to the pipe 52 and the other side is connected to the wheel cylinder 541 and the pressure reducing valve 532. That is, the holding valve 531 is an input valve of the brake actuator 53.

The pressure reducing valve 532 is a normally closed electromagnetic valve and is opened and closed by the brake ECU 6. One side of the pressure reducing valve 532 is connected to the wheel cylinder 541 and the holding valve 531 and the other side is connected to the reservoir 533. When the pressure reducing valve 532 is in an open position, the wheel cylinder 541 connects with the reservoir 533.

The reservoir 533 is to reserve the brake fluid, and is connected to the pipe 52 via the pressure reducing valve 532 and the pump 534. The pump 534 is disposed so that a suction port connects to the reservoir 533 and a discharge port connects to the pipe 52 via a check valve z. Herein, the check valve z is configured to allow a flow from the pump 534 to the pipe 52 (the second fluid pressure chamber 1E) and to restrict a flow from the pipe 52 (the second fluid pressure chamber 1E) to the pump 534. The pump 534 is driven by actuation of the motor 535 corresponding to a command of the brake ECU 6. In a pressure reducing mode of the ABS control, the pump 534 is configured to suck and return the brake fluid in the wheel cylinder 541 or the brake fluid reserved in the reservoir 533 to the second fluid pressure chamber 1E. In the meantime, in order to relax pulsation of the brake fluid discharged from the pump 534, a damper (not shown) is disposed upstream of the pump 534.

The brake actuator 53 as an supply adjuster includes a wheel speed sensor configured to detect a wheel speed. A detection signal indicative of a wheel speed detected by the wheel speed sensor is output to the brake ECU 6.

In the brake actuator 53 configured as described above, the brake ECU 6 is configured to execute an ABS control (antilock brake control) of switching open and close positions of the holding valve 531 and the pressure reducing valve 532, based on the master cylinder pressure, a state of the wheel speed and a front and rear acceleration, actuating the motor 535, as required, to adjust a brake fluid pressure that is applied to the wheel cylinder 541, i.e., a braking force that is applied to the wheel 5FR. That is, the brake actuator 53 is an “supply adjuster” configured to adjust an amount and a timing of the brake fluid supplied from the master cylinder 1, based on an instruction of the brake ECU 6, and to supply the same to the wheel cylinder 541 to the wheel cylinder 544.

In a linear mode to be described later, the fluid pressure delivered from the accumulator 431 of the servo pressure generation device 4 is controlled by the pressure increasing valve 42 and the pressure reducing valve 41, so that the servo pressure is generated in the servo chamber 1A. Thereby, the first master piston 14 and the second master piston 15 are moved forward, so that the first fluid pressure chamber 1D and the second fluid pressure chamber 1E are pressurized. The fluid pressure in the first fluid pressure chamber 1D and the second fluid pressure chamber 1E is supplied from the port 11g and the port 11i to the wheel cylinder 541 to the wheel cylinder 544 via the pipe 51, the pipe 52 and the brake actuator 53, as the master cylinder pressure, so that a fluid pressure braking force is applied to the wheel 5FR to the wheel 5RL.

The brake ECU 6 is an electronic control unit having a microcomputer as a main constitutional component, and is configured to perform communication with diverse sensors 72 to 75, and to control the reactive force valve 3, the separation lock valve 22, the pressure reducing valve 41, the pressure increasing valve 42, the holding valve 531, the pressure reducing valve 532, the motor 433, the motor 535, and the like. The brake ECU 6 has two control modes of a linear mode and an REG mode stored therein. The linear mode is a usual brake control and is a mode in which the pressure reducing valve 41 and the pressure increasing valve 42 are controlled to control the servo pressure in the servo chamber 1A in a state where the separation lock valve 22 is opened and the reactive force valve 3 is closed. The REG mode is a mode in which the pressure reducing valve 41, the pressure increasing valve 42, the separation lock valve 22 and the reactive force valve 3 are set to a non-energization state or a mode in which they are put in the non-energization state (maintaining a normal state) due to a failure or the like. Hereinbelow, the linear mode and REG mode are sequentially described.

The linear mode is first described. In a state where the brake pedal 10 is not depressed, the ball valve 442 closes the passage 444a of the valve seat part 444. Also, the pressure reducing valve 41 is in the open position, and the pressure increasing valve 42 is in the close position. Thereby, the first chamber 4A disconnects from the second chamber 4B.

The second chamber 4B and the servo chamber 1A communicate with each other via the pipe 163, and are kept at the same pressure. The second chamber 4B communicates with the third chamber 4C via the passage 445c and passage 445d of the control piston 445. Therefore, the second chamber 4B and the third chamber 4C communicate with the reservoir 171 via the pipe 414 and the pipe 161. One side of the pressure control chamber 4D is closed by the pressure increasing valve 42, and the other side communicates with the reservoir 171 via the pressure reducing valve 41. Thereby, the pressure control chamber 4D and the second chamber 4B are kept at the same pressure. The fourth chamber 4E and the first fluid pressure chamber 1D communicate with each other via the pipe 511 and the pipe 51, and are kept at the same pressure.

When the brake pedal 10 is depressed from this state, the brake ECU 6 controls the pressure reducing valve 41, the pressure increasing valve 42 and the motor 433, based on information from the pressure sensor 73, the pressure sensor and the pressure sensor 75, after a predetermined regeneration period. That is, the brake ECU 6 performs control of closing the pressure reducing valve 41 and opening the pressure increasing valve 42, thereby controlling the accumulator pressure in the accumulator 431 by the motor 433.

Herein, the pressure increasing valve 42 is put in the open position, so that the accumulator 431 connects with the pressure control chamber 4D of the regulator 44. Also, the pressure reducing valve 41 is put in the close position, so that the pressure control chamber 4D disconnects from the reservoir 171. The high-pressure brake fluid supplied from the accumulator 431 increases the pressure in the pressure control chamber 4D. The pressure in the pressure control chamber 4D is increased, so that the control piston 445 of the regulator 44 is slid toward the cylinder bottom surface-side. Thereby, the tip end of the protrusion 445b of the control piston 445 is brought into contact with the ball valve 442, and the passage 445d is closed by the ball valve 442. The second chamber 4B and the reservoir 171 are cut off each other.

Also, the control piston 445 is slid toward the cylinder bottom surface-side, so that the ball valve 442 is pressurized and moved toward the cylinder bottom surface-side by the protrusion 445b and the ball valve 442 is separated from the valve seat part 444. Thereby, the first chamber 4A and the second chamber 4B communicate with each other via the passage 444a of the valve seat part 444. The first chamber 4A is supplied with the high-pressure brake fluid from the accumulator 431, and the pressure in the second chamber 4B increases due to the communication.

As the pressure in the second chamber 4B increases, the pressure in the servo chamber 1A that communicates with the second chamber 4B is also increased. The pressure in the servo chamber 1A is increased, so that the first master piston 14 is moved forward and the pressure in the first fluid pressure chamber 1D is increased. Also, the pressure in the first fluid pressure chamber 1D is increased, so that the second master piston 15 is moved forward and the pressure in the second fluid pressure chamber 1E is increased. The pressure in the first fluid pressure chamber 1D and the second fluid pressure chamber 1E is increased, so that the high-pressure brake fluid is supplied to the brake actuator 53 and the fourth chamber 4E of the regulator 44. In the meantime, since the pressure in the fourth chamber 4E is increased but the pressure in the pressure control chamber 4D is also similarly increased, the sub-piston 446 is not moved in the regulator 44. In this way, the high-pressure (master cylinder pressure) brake fluid is supplied to the brake actuator 53, so that the brake device 5 is actuated to stop the vehicle. In the linear mode, the force of moving forward the first master piston 14 and the second master piston 15 is equivalent to the force corresponding to the servo pressure.

When releasing the brake operation, the pressure reducing valve 41 is put in the open position, the pressure increasing valve 42 is put in the close position, and the reservoir 171 connects with the pressure control chamber 4D. Thereby, the control piston 445 is retreated, the servo pressure is reduced, and the state before the brake pedal 10 is depressed is restored.

Subsequently, the REG mode is described. In the REG mode, the pressure reducing valve 41, the pressure increasing valve 42, the separation lock valve 22 and the reactive force valve 3 are not energized, the pressure reducing valve 41 is in the open position, the pressure increasing valve 42 is in the close position, the separation lock valve 22 is in the close position, and the reactive force valve 3 is in the open position. Even after the brake pedal 10 is depressed, the non-energization state is kept.

In the REG mode, when the brake pedal 10 is depressed, the input piston 13 is moved forward, and the passage 18 is disconnected, so that the first reactive force chamber 1B and the reservoir 171 are cut off each other. In this state, since the separation lock valve 22 is in the close position, the first reactive force chamber 1B is in a tightly close position. However, the second reactive force chamber 1C communicates with the reservoir 171 because the reactive force valve 3 is in the open position.

Herein, when the brake pedal 10 is further depressed, the input piston 13 is moved forward and the pressure in the first reactive force chamber 1B is increased. The pressure increase in the first reactive force chamber 1B causes the first master piston 14 to move forward. At this time, since the pressure reducing valve 41 and the pressure increasing valve 42 are not energized, the servo pressure is not controlled. That is, the first master piston 14 is moved forward only with the force (pressure in the first reactive force chamber 1B) corresponding to an operating force on the brake pedal 10. Thereby, a volume of the servo chamber 1A increases. However, since the servo chamber 1A communicates with the reservoir 171 via the regulator 44, the servo chamber is replenished with the brake fluid.

As the first master piston 14 is moved forward, the second master piston 15 is also moved forward. When the first master piston 14 and the second master piston 15 are moved forward, the pressure in the first fluid pressure chamber 1D and the second fluid pressure chamber 1E is increased, similarly to the linear mode. As the pressure in the first fluid pressure chamber 1D is increased, the pressure in the fourth chamber 4E is also increased. As the pressure in the fourth chamber 4E is increased, the sub-piston 446 is slid toward the cylinder bottom surface-side. Thereby, the protrusion 445b is brought into contact with the ball valve 442, and the ball valve 442 is moved toward the cylinder bottom surface-side. Therefore, the first chamber 4A and the second chamber 4B communicate with each other and the servo chamber 1A and the reservoir 171 are cut off each other, so that the high-pressure brake fluid is supplied from the accumulator 431 to the servo chamber 1A.

In this way, in the REG mode, when the input piston 13 is moved by a predetermined stroke or greater by the operating force on the brake pedal 10, the accumulator 431 and the servo chamber 1A communicate with each other, and the servo pressure is increased without requiring control. Then, the first master piston 14 (and the second master piston 15) is moved forward by the force corresponding to the servo pressure, in addition to the driver's operating force. Thereby, even in a state where the control is not performed, the high-pressure brake fluid is supplied to the brake actuator 53. In the REG mode, the braking force by which it is possible to safely maintain a vehicle stop state is generated, considering a case where a vehicle is stopped on a slope, and the like.

Also, the brake ECU 6 is configured to detect an abnormality (malfunction, failure), so-called, a single system failure in a master system configured to connect the master cylinder 1 and the wheel cylinder 541 to the wheel cylinder 544 and to supply a master cylinder pressure, and to execute a refresh drive control so as to resolve the detected single system failure. To this end, as shown in FIG. 3, the brake ECU 6 includes a failure detector 61 and a negative pressure generation controller 62.

The failure detector 61 is configured to detect whether a single system failure as a failure has occurred in the master system. When the single system failure in the master system is detected by the failure detector 61, the negative pressure generation controller 62 controls actuation of the servo pressure generation device 4 so as to generate a negative pressure in the master cylinder 1, more specifically, in the first fluid pressure chamber 1D including the first master piston 14 and in the second fluid pressure chamber 1E including the second master piston 15.

Also, as shown in FIG. 3, the brake ECU 6 includes a failure resolution determination circuit 63 and a failure transmitter 64. The failure resolution determination circuit 63 is configured to determine whether the single system failure detected by the failure detector 61 has been resolved by generating a negative pressure in the first fluid pressure chamber 1D and the second fluid pressure chamber 1E with the negative pressure generation controller 62, as described later. When it is determined by the failure resolution determination circuit 63 that the single system failure has not been resolved yet, the failure transmitter 64 notifies a driver (passenger) in a vehicle that the single system failure has occurred.

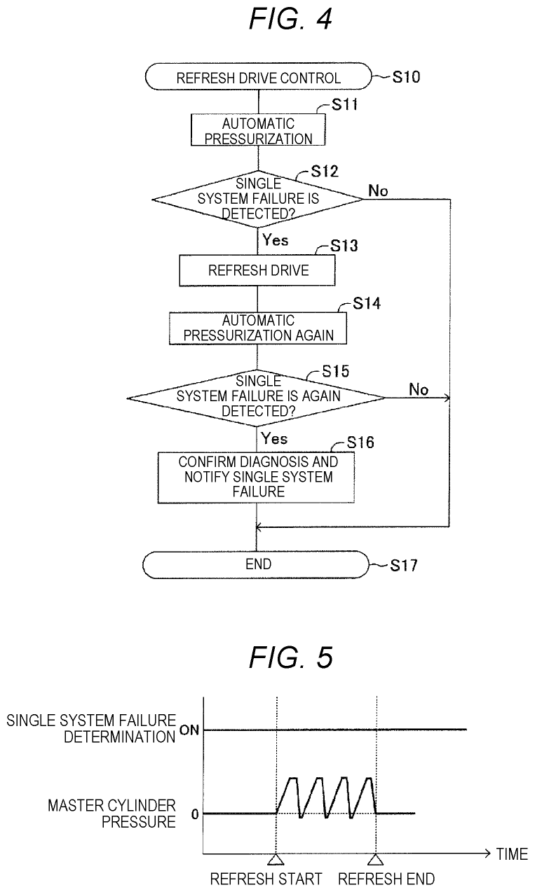

Subsequently, the refresh drive control that is executed by the brake ECU 6 is described. The refresh drive control is executed after a predetermined time (for example, about 2 minutes) elapses since the driver turns off an ignition, for example. In the refresh drive control, the brake ECU 6 executes a refresh drive control program shown in FIG. 4. Hereinbelow, the refresh drive control program is specifically described.

When a predetermined time elapses since the driver gets off the vehicle and the ignition becomes off, the brake ECU 6 starts execution of the refresh drive control program, in step S10. The brake ECU 6 actuates the servo pressure generation device 4 to automatically pressurize the servo chamber 1A, in step S11. Specifically, the brake ECU 6 puts the pressure reducing valve 41 in the close position and the pressure increasing valve 42 in the open position, and drives the motor 433. Thereby, the brake ECU 6 supplies the pressurized brake fluid to the servo chamber 1A to gradually increase the servo pressure in the servo chamber 1A. In the meantime, when automatically pressurizing the servo chamber 1A, the brake ECU 6 energizes the reactive force valve 3 without energizing the separation lock valve 22. As a result, the separation lock valve 22 and the reactive force valve 3 are each put in the close position. When the brake ECU 6 automatically pressurizes the servo chamber 1A, the brake ECU 6 proceeds to step S12.

In step S12, the brake ECU 6 (the failure detector 61) determines whether the single system failure has occurred. Specifically, the brake ECU 6 (the failure detector 61) determines whether the gradually increasing servo pressure is smaller than a preset predetermined value P1, based on a detection value acquired from the pressure sensor 74, and determines whether the reactive force pressure is equal to or greater than a preset predetermined value P2, based on a detection value acquired from the pressure sensor 73. The reactive force pressure becomes equal to or greater than the predetermined value P2 before the servo pressure reaches the predetermined value P1, because the volume of the second reactive force chamber 1C is reduced early and the reactive force pressure to the servo chamber 1A becomes higher than that in the normal state. This situation occurs in a case where the first master piston 14 can slide more easily than in the normal state. Therefore, the situation where the reactive force pressure becomes equal to or higher than the predetermined value P2 before the servo pressure reaches the predetermined value P1 is at least one state of a state where the first master piston 14 can easily slide with respect to the supply of the brake fluid to the servo chamber 1A and a state where the second master piston 15 is pressed by the first master piston 14 and is likely to slide.

When foreign matters or the like are caught between the seal member 92 and seal member 94, which are primary cups, and the main cylinder 11 and the first fluid pressure chamber 1D or the second fluid pressure chamber 1E communicates with the reservoir 172 or the reservoir 173 via the passage 144 or the passage 154, the first master piston 14 (the second master piston 15) can be easily slid. Therefore, when the servo pressure is smaller than the predetermined value P1 and the reactive force pressure is equal to or greater than the predetermined value P2, the brake ECU 6 (the failure detector 61) determines that the single system failure has occurred, determines “Yes” in step S12 and proceeds to step S13. On the other hand, when the servo pressure becomes equal to or greater than the predetermined value P1 before the reactive force pressure becomes equal to or greater than the predetermined value P2, the brake ECU 6 (the failure detector 61) determines “No” in step S12 because the single system failure has not occurred (normal state), and proceeds to step S17 to end the execution of the refresh drive control program. In descriptions below, parts between the seal members 92 and 94 and the main cylinder 11, in which the seal members 92 and 94 are partially bent and the brake fluid can be thus caused to flow, are simply referred to as the outsides of the seal members 92 and 94.

In step S13, the brake ECU 6 (the negative pressure generation controller 62) executes a refresh drive in the master cylinder 1. The refresh drive is processing of generating a negative pressure in the first fluid pressure chamber 1D and the second fluid pressure chamber 1E. Specifically, the refresh drive is to drive the master cylinder 1 so that the brake fluid reserved in the reservoir 172 and the reservoir 173 is caused to forcibly flow to the first fluid pressure chamber 1D and the second fluid pressure chamber 1E through the outer periphery-side of the seal member 92 and the seal member 94 by using the negative pressure, thereby washing out foreign matters on the outer periphery-side, i.e., in the accommodation grooves of the seal member 92 and the seal member 94.

In the present embodiment, the brake ECU 6 (the negative pressure generation controller 62) rapidly reduces the servo pressure after increasing the servo pressure, and slides the first master piston 14 and the second master piston 15 in the axial direction in association with the rapid reduction in the servo pressure, thereby generating a temporary negative pressure in the first fluid pressure chamber 1D and the second fluid pressure chamber 1E, as the refresh drive. Then, the brake ECU 6 sucks the brake fluid from the reservoir 172 and the reservoir 173 toward the first fluid pressure chamber 1D and the second fluid pressure chamber 1E to generate a flow of the brake fluid and thus washes out the foreign matters by the generated negative pressure, in a state where the outer periphery-side of the cup-shaped seal members 92 and 94 is inclined toward a center side. The center side is an inside of the main cylinder 11.

Specifically, the brake ECU 6 (the negative pressure generation controller 62) first disconnects (cuts off) the communication between the reservoir 172 and the first fluid pressure chamber 1D and the communication between the reservoir 173 and the second fluid pressure chamber 1E. To this end, the brake ECU 6 (the negative pressure generation controller 62) actuates the servo pressure generation device 4 to supply the pressurized brake fluid to the servo chamber 1A, thereby moving forward the first master piston 14 and the second master piston 15. Thereby, the seal member 92 is located between the passage 144 formed in the first master piston 14 and the reservoir 172, and the seal member 94 is located between the passage 154 formed in the second master piston 15 and the reservoir 173.

That is, the passage 144 that communicates with the first fluid pressure chamber 1D and the passage 154 that communicates with the second fluid pressure chamber 1E are disconnected from the reservoir 172 and the reservoir 173 by the seal member 92 and the seal member 94, so that a so-called port idle-closed state is formed. Herein, in the port idle-closed state, the first master piston 14 and the second master piston 15 move forward, and the volumes of the first fluid pressure chamber 1D and the second fluid pressure chamber 1E reduce, so that the brake fluid is compressed. As a result, as shown in FIG. 5, the master cylinder pressure increases.

Subsequently, the brake ECU 6 (the negative pressure generation controller 62) rapidly reduces the servo pressure in the servo chamber 1A. That is, the brake ECU 6 (the negative pressure generation controller 62) puts the pressure reducing valve 41 in the open position and the pressure increasing valve 42 in the close position, and the reservoir 171 communicates with the pressure control chamber 4D. Thereby, since the control piston 445 is retreated, the servo pressure is rapidly reduced.

The first master piston 14 is urged rearward by the urging member 143, and the second master piston 15 is urged rearward by the urging member 153. Therefore, when the servo pressure in the servo chamber 1A is rapidly reduced, the first master piston 14 and the second master piston 15 move rearward relative to the main cylinder 11. As a result, as compared to before the servo pressure is rapidly reduced, the volumes of the first fluid pressure chamber 1D and the second fluid pressure chamber 1E increase. In this case, since the port idle is closed and the brake fluid in the first fluid pressure chamber 1D and the second fluid pressure chamber 1E is not caused to flow, the master cylinder pressure, which is a pressure in the first fluid pressure chamber 1D and the second fluid pressure chamber 1E, becomes temporarily a negative pressure, as shown in FIG. 5.

When a negative pressure is generated in the first fluid pressure chamber 1D and the second fluid pressure chamber 1E, the outer periphery-side of the seal member 92 and the seal member 94 is pulled toward the insides of the first fluid pressure chamber 1D and the second fluid pressure chamber 1E. Thereby, the outer periphery-side of the seal member 92 and the seal member 94 is deformed to be inclined toward the center side. Thereby, in the state where the negative pressure is generated in the first fluid pressure chamber 1D and the second fluid pressure chamber 1E, the reservoir 172 and reservoir 173 and the first fluid pressure chamber 1D and second fluid pressure chamber 1E communicate with each other via the passage 144 and passage 154. As a result, the brake fluid reserved in the reservoir 172 and the reservoir 173 passes through the outsides of the seal member 92 and the seal member 94, and flows toward the interior of the first fluid pressure chamber 1D and the second fluid pressure chamber 1E. Therefore, foreign matters existing at the outsides of the seal member 92 and the seal member 94 are washed out (removed) by the flow of the brake fluid.

The brake ECU 6 (the negative pressure generation controller 62) rapidly reduces the servo pressure, and again puts the pressure reducing valve 41 in the open position and the pressure increasing valve 42 in the open position, thereby increasing the servo pressure in the servo chamber 1A. When the refresh drive composed of the increase and rapid reduction in the servo pressure in the servo chamber 1A, i.e., the refresh drive in which the first master piston 14 and the second master piston 15 are actuated like a pumping brake is repeatedly performed in multiple times, as shown in FIG. 5, the brake ECU 6 (the negative pressure generation controller 62) proceeds to step S14.

In step S14, the brake ECU 6 (the failure resolution determination circuit 63) again automatically pressurizes the servo chamber 1A, similarly to step S11, and proceeds to step S15. Then, the brake ECU 6 (the failure resolution determination circuit 63) determines in step S15 whether the single system failure has occurred, similarly to step S12. In other words, the brake ECU 6 determines in step S15 whether the single system failure has been resolved by the refresh drive.

When the servo pressure is smaller than the predetermined value P1, based on a detection value acquired from the pressure sensor 74, and the reactive force pressure is equal to or greater than the predetermined value P2, based on a detection value acquired from the pressure sensor 73, the brake ECU 6 (the failure resolution determination circuit 63) determines “Yes” because the single system failure has not been resolved even by the refresh drive, and proceeds to step S16, similarly to step S12. On the other hand, when the servo pressure becomes equal to or greater than the predetermined value P1 before the reactive force pressure becomes equal to or greater than the predetermined value P2, the brake ECU 6 (the failure resolution determination circuit 63) determines “No” because the single system failure has been resolved by the refresh drive (a normal state), and proceeds to step S17 to end the execution of the refresh drive control program.

In step S16, the brake ECU 6 (the failure transmitter 64) confirms a diagnosis that the single system failure has not been resolved and an abnormality has occurred in the vehicle, as a determination result. Then, the brake ECU 6 (the failure transmitter 64) stores the diagnosis information in a non-volatile memory (not shown), for example. Thereby, the brake ECU 6 (the failure transmitter 64) turns on a warning lamp (not shown) to notify a driver in a vehicle of the diagnosis, for example, when the driver in the vehicle turns on the ignition next time. In this way, when the brake ECU 6 (the failure transmitter 64) stores, as the diagnosis information, that the single system failure has not been resolved (diagnosis confirmation), the brake ECU 6 proceeds to step S17 to end the execution of the refresh drive control program.

As can be understood from the above descriptions, the vehicle braking device of the embodiment includes the master cylinder 1 including the main cylinder 11, the first master piston 14 and second master piston 15 configuring a hollow master piston drivably housed in the main cylinder 11, the first fluid pressure chamber 1D and second fluid pressure chamber 1E that are fluid pressure chambers whose volumes change to reduce in response to movement of the first master piston 14 and the second master piston 15, the port 11f, port 11h, passage 144 and passage 154 as the communication hole formed in the main cylinder 11 so that the reservoir 172 and reservoir 173 configured to reserve the brake fluid and the inside of the main cylinder 11 communicate with each other, and the seal member 92 and seal member 94 that are made of elastic material provided between the inner peripheral surface of the main cylinder 11 and the outer peripheral surfaces of the first master piston 14 and second master piston 15 and between the port 11f, port 11h, passage 144 and the passage 154 and the first fluid pressure chamber 1D and second fluid pressure chamber 1E; the failure detector 61 configured to detect the single system failure that is a failure of the master system including the master cylinder 1, the master cylinder pressure being supplied to the master system; and the negative pressure generation controller 62 that, when the failure is detected by the failure detector 61, moves the first master piston 14 and the second master piston 15 to generate a negative pressure in the first fluid pressure chamber 1D and the second fluid pressure chamber 1E.

In this case, the vehicle braking device further includes the servo pressure generation device 4 as the servo pressure generator configured to supply the servo pressure to the servo chamber 1A formed by the main cylinder 11 and the first master piston 14 and second master piston 15 for moving the first master piston 14 and the second master piston 15, irrespective of an operation on the brake pedal 10 that is a brake operation member. The negative pressure generation controller 62 is configured to control the servo pressure generation device 4 to move the first master piston 14 and the second master piston 15, thereby generating the negative pressure in the first fluid pressure chamber 1D and the second fluid pressure chamber 1E.

According to the above configurations, when the single system failure that has occurred in the master system is detected by the failure detector 61, the negative pressure generation controller 62 can automatically move (move forward) the first master piston 14 and the second master piston 15 only with the servo pressure generated by actuation of the servo pressure generation device 4, thereby cutting off the communication between the port 11f and port 11h and the passage 144 and passage 154, in other words, the communication between the reservoir 172 and reservoir 173 and the first fluid pressure chamber 1D and second fluid pressure chamber 1E by the seal member 92 and the seal member 94. The negative pressure generation controller 62 can generate the negative pressure in the first fluid pressure chamber 1D and the second fluid pressure chamber 1E provided to the master cylinder 1, in the state where the communication between the port 11f and port 11h and the passage 144 and passage 154 is cut off.

The negative pressure is generated in the first fluid pressure chamber 1D and the second fluid pressure chamber 1E, in this way, so that a pressure difference from a side of the reservoir 172 and reservoir 173, i.e., from an atmospheric pressure becomes large. By the pressure difference, parts (the outsides of the cup seals) of the seal member 92 and the seal member 94 can be forcibly elastically deformed. Thereby, the brake fluid reserved in the reservoir 172 and the reservoir 173 can be caused to flow toward the first fluid pressure chamber 1D and the second fluid pressure chamber 1E subjected to the negative pressure, through the seal member 92 and the seal member 94 by which foreign matters are caught. Therefore, the foreign matters caught by the seal member 92 and the seal member 94 can be easily washed out by the flow of the brake fluid, so that it is possible to increase a possibility of resolving the single system failure having occurred in the master system.

In this case, the negative pressure generation controller 62 can actuate the servo pressure generation device 4 so as to repeatedly exchange a state of increasing the servo pressure and a state of reducing the servo pressure, thereby generating the negative pressure in the first fluid pressure chamber 1D and the second fluid pressure chamber 1E.

According to the above configuration, the negative pressure generation controller 62 can increase the servo pressure to decrease the volumes of the first fluid pressure chamber 1D and the second fluid pressure chamber 1E (i.e., to increase the master cylinder pressure) and then reduce the servo pressure to increase the volumes of the first fluid pressure chamber 1D and the second fluid pressure chamber 1E (i.e., reduce the master cylinder pressure), in the state where the communication between the port 11f and port 11h and the passage 144 and passage 154 is cut off. Thereby, since the first fluid pressure chamber 1D and the second fluid pressure chamber 1E increase or decrease in volume without the brake fluid being supplied from the reservoir 172 and the reservoir 173, the negative pressure is temporarily generated therein. Therefore, the negative pressure generation controller 62 can easily generate the negative pressure in the first fluid pressure chamber 1D and the second fluid pressure chamber 1E simply by actuating the servo pressure generation device 4 in a so-called pumping brake manner. As a result, it is possible to easily wash out the foreign matters caught between the seal member 92 and seal member 94 and the main cylinder 11 by the flow of the brake fluid, so that it is possible to increase a possibility of resolving the single system failure having occurred in the master system.

Also, in this case, the vehicle braking device may include the failure resolution determination circuit 63 that determines whether the single system failure occurred in the master system has been resolved, after the negative pressure generation controller 62 generates the negative pressure in the first fluid pressure chamber 1D and the second fluid pressure chamber 1E, and the failure transmitter 64 configured to notify that the single system failure has not been resolved yet according a determination result by the failure resolution determination circuit 63.

According to the above configuration, the failure resolution determination circuit 63 can determine whether the single system failure occurred in the master system has been resolved, after the refresh drive is executed by the negative pressure generation controller 62. When it is determined by the failure resolution determination circuit 63 that the single system failure has not been resolved yet, the failure transmitter 64 can notify the driver in the vehicle that the single system failure has occurred. Thereby, the driver in the vehicle can perceive more securely that the single system failure has not been resolved, so that it is possible to repair the vehicle at a repair factory or the like, for example.

### Modified Embodiments

In the above embodiment, the brake ECU 6 (the negative pressure generation controller 62) increases and rapidly reduces the servo pressure in the servo chamber 1A in a similar manner to the so-called pumping brake, and slides the first master piston 14 and the second master piston 15 of the master cylinder 1 in the front and rear direction, thereby generating the negative pressure in the first fluid pressure chamber 1D and the second fluid pressure chamber 1E, as the refresh drive. Then, the brake ECU 6 generates the flow of the brake fluid on the outer periphery-side of the seal member 92 and the seal member 94 by the generated negative pressure, thereby washing out (removing) the foreign matters. Instead of or in addition to this configuration, the brake ECU 6 (the negative pressure generation controller 62) may execute the refresh drive of actuating the brake actuator 53 of the brake device 5 to generate the negative pressure in the first fluid pressure chamber 1D and the second fluid pressure chamber 1E. Hereinbelow, this modified embodiment is described.

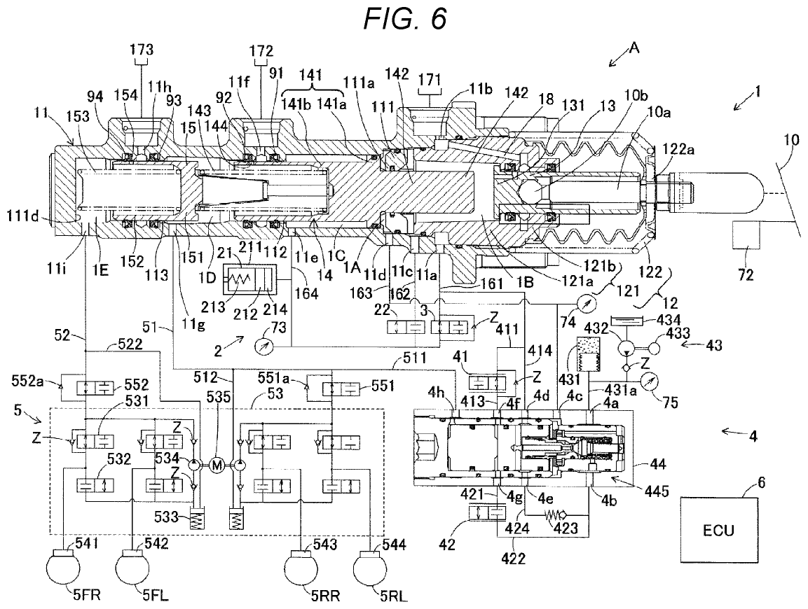

In the modified embodiment, as shown in FIG. 6, the brake device 5 includes a master cutoff valve 551 and a master cutoff valve 552 as a switching valve, which are normally open electromagnetic valves, on the pipe 51 and the pipe 52. Also, in the modified embodiment, an auxiliary pipe 512 and an auxiliary pipe 522 branched from the pipe 51 and the pipe 52 on a further upstream side than the master cutoff valve 551 and the master cutoff valve 552 are provided so as to communicate the first fluid pressure chamber 1D and second fluid pressure chamber 1E of the master cylinder 1 and the reservoir 533 each other. In the meantime, in descriptions below, the master cutoff valve 551 and the master cutoff valve 552 as a switching valve are also simply referred to as the SM valve 551 and the SM valve 552.

When the SM valve 551 is in the open position, the master cylinder 1 (the first fluid pressure chamber 1D) connects with the brake actuator 53. When the SM valve 551 is in the close position, the master cylinder 1 disconnect from the brake actuator 53. The SM valve 551 includes a check valve 551a. The check valve 551a as one-way valve is provided with bypassing the SM valve 551, and is configured to allow a flow from the master cylinder 1 (the first fluid pressure chamber 1D) toward the brake actuator 53, and to restrict a flow from the brake actuator 53 as the supply adjuster toward the master cylinder 1 (the first fluid pressure chamber 1D).

When the SM valve 552 is in the open position, the master cylinder 1 (the second fluid pressure chamber 1E) connects with the brake actuator 53. When the SM valve 552 is in the close position, the master cylinder 1 disconnects from the brake actuator 53. The SM valve 552 includes a check valve 552a. The check valve 552a as one-way valve is provided with bypassing the SM valve 552, and is configured to allow a flow from the master cylinder 1 (the second fluid pressure chamber 1E) toward the brake actuator 53, and to restrict a flow from the brake actuator 53 toward the master cylinder 1 (the second fluid pressure chamber 1E).

In the modified embodiment, the brake ECU 6 (the negative pressure generation controller 62) is configured to drive the SM valve 551, the SM valve 552 and the brake actuator 53 of the brake device 5 to suck the brake fluid in the first fluid pressure chamber 1D and the second fluid pressure chamber 1E, thereby generating a temporary negative pressure in the first fluid pressure chamber 1D and the second fluid pressure chamber 1E, as the refresh drive, in step S13 of the refresh drive control program shown in FIG. 3.

Specifically, the brake ECU 6 (the negative pressure generation controller 62) first actuates the servo pressure generation device 4 to supply the pressurized brake fluid to the servo chamber 1A, thereby moving forward the first master piston 14 and the second master piston 15, in the similar manner to the above embodiment. Thereby, the brake ECU 6 disconnects (cuts off) the communication between the reservoir 172 and the first fluid pressure chamber 1D, and the communication between the reservoir 173 and the second fluid pressure chamber 1E.

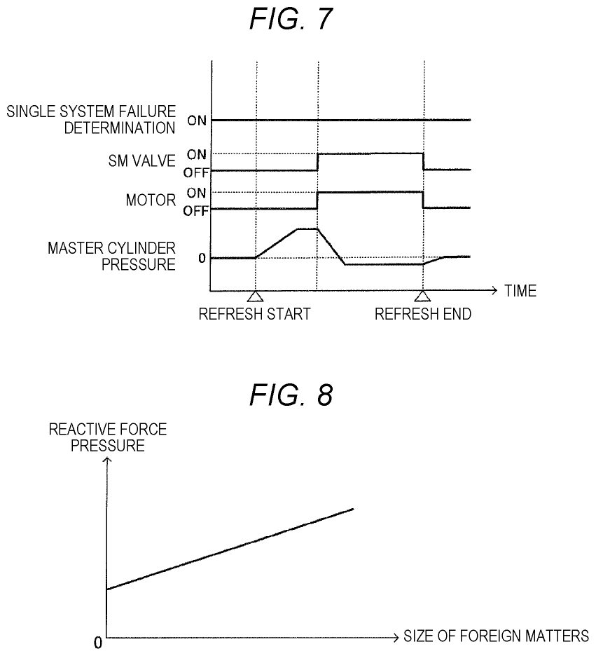

In a state where the first master piston 14 and the second master piston 15 has moved forward in this way, the brake ECU 6 (the negative pressure generation controller 62) switches the SM valve 551 to the close position and the SM valve 552 to the close position, as shown in FIG. 7. Thereby, even when the pump 534 (the motor 535) of the brake actuator 53 is actuated, the flow of the brake fluid from the brake actuator 53 into the first fluid pressure chamber 1D via the pipe 51 is cut off, and the flow of the brake fluid from the brake actuator 53 into the second fluid pressure chamber 1E via the pipe 52 is cut off.

The brake ECU 6 (the negative pressure generation controller 62) puts the holding valve 531 and pressure reducing valve 532 of the brake actuator 53 in the open position, and actuates the motor 535, as shown in FIG. 7. Thereby, in the brake actuator 53, as the motor 535 is actuated, the brake fluid reserved in the reservoir 533 circulates, and the brake fluid in the first fluid pressure chamber 1D and the second fluid pressure chamber 1E is sucked toward the reservoir 533 of the brake actuator 53 via the auxiliary pipe 512 and the auxiliary pipe 522.

In the modified embodiment, in the port idle-closed state, the brake fluid in the first fluid pressure chamber 1D and the second fluid pressure chamber 1E is sucked. Therefore, as shown in FIG. 7, the master cylinder pressure that is a pressure in the first fluid pressure chamber 1D and the second fluid pressure chamber 1E is reduced to a negative pressure. When the pressure in the first fluid pressure chamber 1D and the second fluid pressure chamber 1E becomes a negative pressure, the outer periphery-side of the seal member 92 and the seal member 94 is pulled toward the insides of the first fluid pressure chamber 1D and the second fluid pressure chamber 1E. Therefore, the outer periphery-side of the seal member 92 and the seal member 94 is deformed to be inclined toward the center side.

Thereby, in the state where the motor 535 of the brake actuator 53 is actuated and thus the pressure in the first fluid pressure chamber 1D and the second fluid pressure chamber 1E becomes a negative pressure, the reservoir 172 and reservoir 173 and the first fluid pressure chamber 1D and second fluid pressure chamber 1E communicate with each other via the passage 144 and the passage 154. As a result, the brake fluid reserved in the reservoir 172 and the reservoir 173 passes through the outsides of the seal member 92 and the seal member 94, and flows toward the insides of the first fluid pressure chamber 1D and the second fluid pressure chamber 1E. Therefore, the foreign matters existing on the outsides of the seal member 92 and the seal member 94 are washed out (removed) by the flow of the brake fluid.

As such, in the modified embodiment, the brake ECU 6 (the negative pressure generation controller 62) actuates the motor 535 of the brake actuator 53, i.e., actuates the brake actuator 53 until a predetermined time elapses, thereby performing the refresh drive. When the brake ECU 6 performs the refresh drive in step S13, the brake ECU 6 executes each step after step S14, similarly to the above embodiment.

As can be understood from the above descriptions, the vehicle braking device A in the modified embodiment further includes the brake actuator 53 as the supply adjuster configured to suck the brake fluid in the first fluid pressure chamber 1D and the second fluid pressure chamber 1E and disposed between the first fluid pressure chamber 1D and second fluid pressure chamber 1E and the wheel cylinder 541, wheel cylinder 542, wheel cylinder 543 and wheel cylinder 544 configured to apply the braking force to the wheel 5FR, wheel 5FL, wheel 5RR and wheel 5RL, and the negative pressure generation controller 62 is configured to suck the brake fluid from the brake fluid in the first fluid pressure chamber 1D and the second fluid pressure chamber 1E, thereby driving the first master piston 14 and the second master piston 15 to generate the negative pressure in the first fluid pressure chamber 1D and the second fluid pressure chamber 1E.

In this case, the vehicle braking device A includes the SM valve 551 and the SM valve 552 as a switching valve disposed between the first fluid pressure chamber 1D and second fluid pressure chamber 1E and the brake actuator 53 and configured to switch to the open position in which the first fluid pressure chamber 1D and second fluid pressure chamber 1E and the brake actuator 53 communicate with each other or the close position in which they are cut off, and the negative pressure generation controller 62 is configured to switch the SM valve 551 and the SM valve 552 to the close position, and to drive the pump 534 of the brake actuator 53 so as to suck the brake fluid from the first fluid pressure chamber 1D and the second fluid pressure chamber 1E, thereby generating the negative pressure in the first fluid pressure chamber 1D and the second fluid pressure chamber 1E.

According to the above configurations, in the state where the communication between the port 11f and port 11h and the passage 144 and passage 154 is cut off and the SM valve 551 and the SM valve 552 are switched to the close position, the negative pressure generation controller 62 can drive the pump 534 of the brake actuator 53, thereby sucking the brake fluid from the first fluid pressure chamber 1D and the second fluid pressure chamber 1E via the auxiliary pipe 512 and the auxiliary pipe 522. Thereby, since the brake fluid is sucked by the pump 534 without the brake fluid being supplied from the reservoir 172 and the reservoir 173, the negative pressure is generated in the first fluid pressure chamber 1D and the second fluid pressure chamber 1E. Therefore, the negative pressure generation controller 62 can easily generate the negative pressure in the first fluid pressure chamber 1D and the second fluid pressure chamber 1E simply by actuating the brake actuator 53, similarly to the usual side slip prevention control, for example. As a result, it is possible to easily wash out the foreign matters caught by the seal member 92 and the seal member 94 by the flow of the brake fluid, similarly to the above embodiment, so that it is possible to increase a possibility of resolving the single system failure having occurred in the master system.

When implementing the present disclosure, the present disclosure is not limited to the above embodiment and the modified embodiment, and a variety of changes can be made without departing from the object of the present disclosure.

For example, in the above embodiment and the modified embodiment, the brake ECU 6 (the negative pressure generation controller 62) is configured to uniformly generate the negative pressure in the first fluid pressure chamber 1D and the second fluid pressure chamber 1E, irrespective of the state of the foreign matters existing on the outsides of the seal member 92 and the seal member 94. In this case, the brake ECU 6 (the negative pressure generation controller 62) may change a state of the negative pressure that is generated in the first fluid pressure chamber 1D and the second fluid pressure chamber 1E, in accordance with a state of the foreign matters causing the single system failure, for example, a size of the foreign matters.

Specifically, the reactive force pressure that is a detection value acquired from the pressure sensor 73 and a degree of the failure having occurred in the master system, specifically, the size of the foreign matters existing on the outsides of the seal member 92 and the seal member 94 meet a relation in which as the size of the foreign matters increases, the reactive force pressure increases, as shown in FIG. 8, for example. That is, as the larger foreign matters exist on the outsides of the seal member 92 and the seal member 94, the first master piston 14 and the second master piston 15 are more likely to move forward, so that the reactive force pressure increases. Therefore, the brake ECU 6 (the failure detector 61) specifies that the larger foreign matters exist on the outsides of the seal member 92 and the seal member 94 as the reactive force pressure acquired from the pressure sensor 73 increases, based on the relation shown in FIG. 8, thereby detecting that the single system failure has occurred.

When the large foreign matters exist, the brake ECU 6 (the negative pressure generation controller 62) sets the higher negative pressure that is generated in the first fluid pressure chamber 1D and the second fluid pressure chamber 1E, as compared to a case where the small foreign matters exist, and actuates the servo pressure generation device 4 or/and the brake actuator 53 (the motor 535). Thereby, it is possible to generate the negative pressure in the first fluid pressure chamber 1D and the second fluid pressure chamber 1E, in accordance with the state (size) of the foreign matters existing on the outsides of the seal member 92 and the seal member 94 and causing the single system failure, i.e., with specifying a degree of the failure. As a result, it is possible to wash out more securely the foreign matters, so that it is possible to improve the possibility of resolving the single system failure.

Also, in the above embodiment and the modified embodiment, the regulator 44 includes the ball valve 442. However, the regulator 44 is not limited to the configuration where the ball valve 442 is used, and may have a configuration where a spool valve is used, for example.

Also, in the above embodiment and the modified embodiment, the pressure supply unit 43 of the servo pressure generation device 4 includes the accumulator 431, the fluid pressure pump 432, the motor 433 and the reservoir 434. Instead, the servo pressure generation device 4 may include an electric pressure supply unit configured to directly pressurize the brake fluid by a drive force of the motor, thereby outputting the servo pressure. Like this, in a case where the pressure supply unit is configured to electrically operate, when determining the state (size) of the foreign matters, the brake ECU 6 (the failure detector 61) may determine that as the power that is supplied to the pressure supply unit becomes lower, the larger foreign matters exist on the outsides of the seal member 92 and the seal member 94, for example.

Also, in the above embodiment and the modified embodiment, the brake ECU 6 includes the failure resolution determination circuit 63 and the failure transmitter 64. Instead, the brake ECU 6 may not include the failure resolution determination circuit 63 and the failure transmitter 64. In this case, another system mounted on the vehicle may determine whether the single system failure has been resolved and notify the driver (passenger) that the single system failure has not been resolved.

Also, in the above embodiment and the modified embodiment, the brake ECU 6 generates multiple times the negative pressure in the first fluid pressure chamber 1D and the second fluid pressure chamber 1E, in step S13. However, the brake ECU 6 may generate once the negative pressure in the first fluid pressure chamber 1D and the second fluid pressure chamber 1E. In this case, the brake ECU 6 may generate once the negative pressure in the first fluid pressure chamber 1D and the second fluid pressure chamber 1E in step S13, and then proceed to step S14.

1. A vehicle braking device comprising:
a master cylinder comprising a main cylinder, a master piston drivably housed in the main cylinder, a fluid pressure chamber whose volume changes in response to movement of the master piston, a communication hole formed in the main cylinder so that a reservoir for reserving a brake fluid communicates with an inside of the main cylinder through the communication hole, a seal member made of an elastic material, the seal member provided between an inner peripheral surface of the main cylinder and an outer peripheral surface of the master piston, and the seal member provided between the communication hole and the fluid pressure chamber;
a failure detector configured to detect a failure of a master system comprising the master cylinder; and
a negative pressure generation controller that, when the failure is detected by the failure detector, moves the master piston to generate a negative pressure in the fluid pressure chamber.

2. The vehicle braking device according to claim 1, further comprising a servo pressure generator configured to supply a servo pressure for moving the master cylinder in a servo chamber formed in the master cylinder, irrespective of an operation on a brake operation member,
wherein the negative pressure generation controller is configured to move the master piston by controlling the servo pressure generator, thereby generating the negative pressure in the fluid pressure chamber.

3. The vehicle braking device according to claim 2, wherein the negative pressure generation controller is configured to actuate the servo pressure generator so as to repeatedly exchange a state of increasing the servo pressure and a state of reducing the servo pressure, thereby generating the negative pressure in the fluid pressure chamber.

4. The vehicle braking device according to claim 1, further comprising a supply adjuster disposed between the fluid pressure chamber and a wheel cylinder configured to apply a braking force to a wheel, and configured to suck the brake fluid in the fluid pressure chamber,
wherein the negative pressure generation controller is configured to move the master piston by sucking the brake fluid from the fluid pressure chamber, thereby generating the negative pressure in the fluid pressure chamber.

5. The vehicle braking device according to claim 4, further comprising a switching valve disposed between the fluid pressure chamber and the supply adjuster, and configured to switch to an open position in which the fluid pressure chamber connects with the supply adjuster or a close position in which the fluid pressure chamber disconnect from the supply adjuster,
wherein the negative pressure generation controller is configured to close the switching valve, and to drive the supply adjuster so as to suck the brake fluid from the fluid pressure chamber, thereby generating the negative pressure in the fluid pressure chamber.

6. The vehicle braking device according to claim 1, further comprising:
a failure resolution determination circuit configured to determine whether the failure having occurred in the master system has been resolved after the negative pressure generation controller generates the negative pressure in the fluid pressure chamber, and
a failure transmitter configured to notify that the failure has not been resolved yet according a determination result by the failure resolution determination circuit.

7. The vehicle braking device according to claim 1, wherein the failure detector is configured to specify a degree of the failure having occurred in the master system, and
wherein the negative pressure generation controller is configured to regulate the negative pressure that is generated in the fluid pressure chamber in accordance with the degree of the failure specified by the failure detector.

8. The vehicle braking device according to one of claim 2, further comprising:
a failure resolution determination circuit configured to determine whether the failure having occurred in the master system has been resolved after the negative pressure generation controller generates the negative pressure in the fluid pressure chamber, and
a failure transmitter configured to notify that the failure has not been resolved yet according a determination result by the failure resolution determination circuit.

9. The vehicle braking device according to claim 2, wherein the failure detector is configured to specify a degree of the failure having occurred in the master system, and
wherein the negative pressure generation controller is configured to regulate the negative pressure that is generated in the fluid pressure chamber in accordance with the degree of the failure specified by the failure detector.

10. The vehicle braking device according to one of claim 3, further comprising:
a failure resolution determination circuit configured to determine whether the failure having occurred in the master system has been resolved after the negative pressure generation controller generates the negative pressure in the fluid pressure chamber, and
a failure transmitter configured to notify that the failure has not been resolved yet according a determination result by the failure resolution determination circuit.

11. The vehicle braking device according to claim 3, wherein the failure detector is configured to specify a degree of the failure having occurred in the master system, and
wherein the negative pressure generation controller is configured to regulate the negative pressure that is generated in the fluid pressure chamber in accordance with the degree of the failure specified by the failure detector.

12. The vehicle braking device according to one of claim 4, further comprising:
a failure resolution determination circuit configured to determine whether the failure having occurred in the master system has been resolved after the negative pressure generation controller generates the negative pressure in the fluid pressure chamber, and
a failure transmitter configured to notify that the failure has not been resolved yet according a determination result by the failure resolution determination circuit.

13. The vehicle braking device according to claim 4, wherein the failure detector is configured to specify a degree of the failure having occurred in the master system, and
wherein the negative pressure generation controller is configured to regulate the negative pressure that is generated in the fluid pressure chamber in accordance with the degree of the failure specified by the failure detector.

14. The vehicle braking device according to one of claim 5, further comprising:
a failure resolution determination circuit configured to determine whether the failure having occurred in the master system has been resolved after the negative pressure generation controller generates the negative pressure in the fluid pressure chamber, and
a failure transmitter configured to notify that the failure has not been resolved yet according a determination result by the failure resolution determination circuit.

15. The vehicle braking device according to claim 5, wherein the failure detector is configured to specify a degree of the failure having occurred in the master system, and
wherein the negative pressure generation controller is configured to regulate the negative pressure that is generated in the fluid pressure chamber in accordance with the degree of the failure specified by the failure detector.

16. The vehicle braking device according to claim 6, wherein the failure detector is configured to specify a degree of the failure having occurred in the master system, and
wherein the negative pressure generation controller is configured to regulate the negative pressure that is generated in the fluid pressure chamber in accordance with the degree of the failure specified by the failure detector.
